(19) United States
(12) Patent Application Publication
(10) Pub. No.: US 2017/0195704 A1
(43) Pub. Date: Jul. 6, 2017

(54) APPARATUS AND METHOD FOR PROVIDING VOD CONTENT BASED ON NETWORK LOAD DISTRIBUTION

(71) Applicant: Hyeon Cheol ZIN, (US)

(72) Inventor: Hyeon Cheol ZIN, Gyeongsangbuk-do (KR)

(21) Appl. No.: 14/779,011

(22) PCT Filed: Jul. 3, 2014
(86) PCT No.: PCT/KR2014/005932

§ 371 Date: Jul. 29, 2016

(30) Foreign Application Priority Data
Jul. 10, 2013 (KR) 10-2013-0081113

(51) Int. Cl. H04N 21/262; H04N 21/24; H04N 21/45; H04N 21/442; H04N 21/2543; H04N 21/472

(52) U.S. Cl. CPC H04N 21/26216; H04N 21/26241; H04N 21/2543; H04N 21/47202; H04N 21/4532; H04N 21/44222; H04N 21/2402

(57) ABSTRACT

An apparatus for providing VOD content based on network load distribution according to an embodiment of the present invention, comprises: a download management unit for pre-downloading a content preferred by a viewer during a network idle time before a view request from the viewer, the network idle time being defined as a time in which the network load is less than a reference set value; a content payment unit for paying for the pre-downloaded content preferred by the viewer according to the view request from the viewer; and a content playing unit for playing the paid content preferred by the viewer and providing the content to the viewer.

### TECHNICAL FIELD

Exemplary embodiments of the present invention relate to an apparatus and method for providing a VOD content based on a network load distribution.

### BACKGROUND ART

In general, a set-top box is connected to an image reproduction device (or a display device) such as a television and that receives a signal entering from the outside and that appropriately converts the signal and that displays a content thereof in the image reproduction device. A device that gives an external signal to the set-top box includes an Ethernet cable, a satellite wave receiving antenna, a coaxial cable, a phone line, and a general very high frequency (VHF) or ultra-high frequency (UHF) antenna.

Nowadays, a set-top box that supports a user to use a service such as Internet search by transmitting and receiving an Internet data signal through a cable network as well as a function of receiving a cable broadcasting signal to display the cable broadcasting signal in an image reproduction device has been launched.

One of services that have recently been in the spotlight using a set-top box that can perform an Internet search in this way is a Video on Demand (VOD) service. The VOD service can provide a program including an image, a voice, and information such as a drama or a movie at a time at which a viewer wants.

The related conventional art is Korean Patent Laid-Open Publication No. 10-2011-0114162 (title of invention: VOD content service system and method using VOD virtual channel, Laid-Open date: Oct. 19, 2011).

### DETAILED DESCRIPTION OF INVENTION

### Technical Problem

An exemplary embodiment of the present invention provides an apparatus and method for providing a VOD content based on a network load distribution that analyzes contents viewed by a viewer and that previously downloads and stores a content having a high possibility to view and that immediately reproduces the stored content at a time point in which the viewer requests.

The object of the present invention is not limited to the above-described object(s) and the other object(s) will be understood by those skilled in the art from the following description.

### Technical Solution

In accordance with an aspect of the present invention, a VOD content providing apparatus based on a network load distribution includes: a download management unit that previously downloads a viewer preference content before a viewing request from a viewer is input in a network idle time period defined to a time period in which a network load is smaller than a reference setting value; a content payment unit that performs payment on the previously downloaded viewer preference content according to the viewing request from the viewer; and a content reproduction unit that reproduces the viewer preference content in which payment is complete and that provides the viewer preference content to the viewer.

The download management unit may include: a history storage unit that stores history information of Video On Demand (VOD) contents viewed by the viewer; an information analysis unit that analyzes the history information and that estimates at least one VOD content having a high possibility in which the viewer may view in the future based on an analysis result of the history information; a content selection unit that selects the estimated at least one VOD content to the viewer preference content; and a content download unit that downloads the selected viewer preference content in the network idle time period.

An analysis result of the history information may include at least one of the viewing frequency number of the viewed contents, a viewing date and time, a viewing duration time, the broadcasting episode number, and information on whether a subsequent episode exists.

The VOD content providing apparatus may further include a content determination unit that determines whether a viewer preference content in which the viewer wants to view exists in a download list including the downloaded viewer preference content, wherein the content payment unit may perform, if a viewer preference content in which the viewer wants to view exists, payment on a corresponding viewer preference content.

The VOD content providing apparatus may further include a content sharing unit that searches for a storage list of the set-top box within the same network and that receives a corresponding viewer preference content, if a viewer preference content in which the viewer wants to view does not exist in the download list.

The download management unit may access to the content server to download a corresponding viewer preference content in real time, when the corresponding viewer preference content is not found in the storage list of the set-top box within the same network.

The download management unit may delete the previously downloaded viewer preference content, when the previously downloaded viewer preference content is not reproduced during a predetermined time.

The download management unit may calculate a duration time and a download velocity of the network idle time period, calculate the download available number of the viewer preference contents during the duration time based on the download velocity, and previously download the viewer preference contents corresponding to the download available number in the network idle time period.

In accordance with another aspect of the present invention, a method of providing a VOD content based on a network load distribution includes: previously downloading, by a download management unit of a VOD content providing apparatus, a viewer preference content before a viewing request from a viewer is input in a network idle time period defined to a time period in which a network load is smaller than a reference setting value; performing, by a content payment unit of the VOD content providing apparatus, payment on the previously downloaded viewer preference contents according to the viewing request from the viewer; and reproducing, by a content reproduction unit of the VOD content providing apparatus, the viewer preference content in which payment is complete and providing the viewer preference content to the viewer.

The previously downloading of a viewer preference content may include: storing, by a history storage unit of the download management unit, history information of a VOD content viewed by the viewer; analyzing, by an information analysis unit of the download management unit, the history information and estimating at least one VOD content having a high possibility in which the viewer may view in the future based on an analysis result of the history information; selecting, by a content selection unit of the download management unit, the estimated at least one VOD content to the viewer preference content; and downloading, by a content download unit of the download management unit, the selected viewer preference content in the network idle time period.

The method may further include determining, by a content determination unit of the VOD content providing apparatus, whether a viewer preference content in which the viewer wants to view exists in a download list including the downloaded viewer preference content, wherein the performing of payment may include performing, if a viewer preference content in which the viewer wants to view exists, payment on a corresponding viewer preference content.

The method may further include searching for, if a viewer preference content in which the viewer wants to view does not exist in the download list, by a content sharing unit of the VOD content providing apparatus, a storage list of a set-top box within the same network and receiving a corresponding viewer preference content.

The method may further include: calculating, by the download management unit of the VOD content providing apparatus, a duration time and a download velocity of the network idle time period; calculating, by the download management unit of the VOD content providing apparatus, the download available number of the viewer preference contents during the duration time based on the download velocity; and previously downloading, by the download management unit of the VOD content providing apparatus, the viewer preference content corresponding to the download available number in the network idle time period.

The detailed matters of the embodiments will be included in the detailed description and the accompanying drawings.

### Advantageous Effects

According to an exemplary embodiment of the present invention, contents viewed by a viewer are analyzed, contents having a high possibility to view are previously downloaded and stored, and at a time point in which the viewer requests, the stored contents are reproduced.

According to an exemplary embodiment of the present invention, by reducing a download time without delay of a network, a viewer can more quickly view contents.

According to an exemplary embodiment of the present invention, contents in which a viewer requests can be permanently stored, and because a download time of contents is reduced, a communication cost can be saved.

### BRIEF DESCRIPTION OF DRAWINGS

FIG. 1 is a diagram illustrating a network configuration of a general VOD system.

FIG. 2 is a block diagram illustrating a VOD content providing apparatus based on a network load distribution according to an exemplary embodiment of the present invention.

FIG. 3 is a block diagram illustrating a configuration of a download management unit of FIG. 2.

FIG. 4 is a table illustrating an analysis result of history information of VOD contents according to an exemplary embodiment of the present invention.

FIG. 5 is a flowchart illustrating a method of providing a VOD content based on a network load distribution according to an exemplary embodiment of the present invention.

FIGS. 6 and 7 are flowcharts illustrating a process of previously downloading viewer preference contents in a network idle time period according to an exemplary embodiment of the present invention.

FIG. 8 is a flowchart illustrating a process of sharing a content according to an exemplary embodiment of the present invention.

### BEST MODES FOR CARRYING OUT THE INVENTION

Advantages and/or characteristics of the present invention and a method of attaining them will become more readily apparent from the detailed description given hereinafter together with the attached drawings. However, it should be understood that the detailed description and specific examples while indicating preferred embodiments of the invention are given by way of illustration only since various changes and modifications within the spirit and scope of the invention will become apparent to those skilled in the art from this detailed description. Like reference numerals designate like elements throughout the specification.

Hereinafter, exemplary embodiments of the present invention will be described in detail with reference to the accompanying drawings.

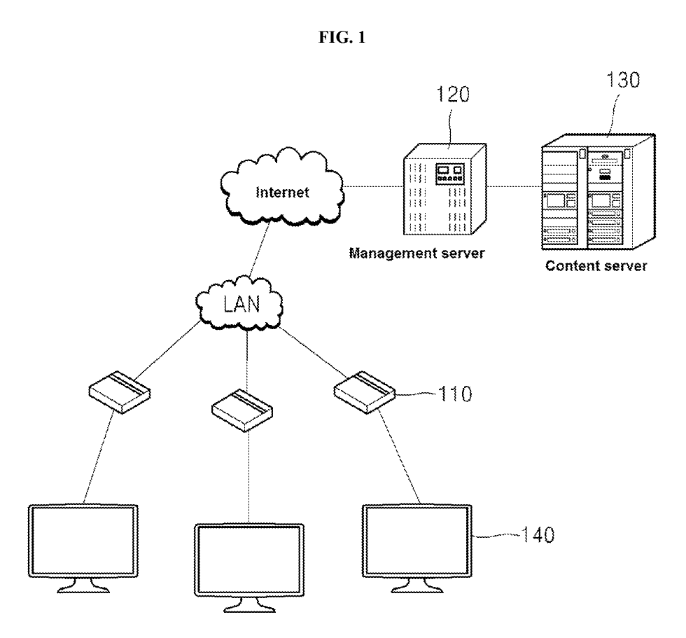

FIG. 1 is a diagram illustrating a network configuration of a general VOD system.

Referring to FIG. 1, a Video On Demand (VOD) service by a set-top box 110 is to provide information such as movie, music, news, and home shopping in real time according to a user's VOD service request.

Because such information is provided in real time, after access to a service is terminated, when the same information is again requested, a VOD service should be again requested. Therefore, due to frequent access to the VOD service, a user's cost burden increases and user inconvenience increases.

Nowadays, a demand for a VOD service increases according to spread increase of an Internet Protocol Television (IPTV) and a digital cable TV, but there is a problem such as delay broadcasting and reaction velocity decline according to network traffic increase.

However, it may be considered that a network idle time period, for example, a daily work time, a rest time, a viewing time, and a sleep time exist according to a daily life pattern and that viewer preference contents, which are contents in which a viewer prefers are similar according to a residential community form and that storage space is sufficient according to memory price decline.

That is, in consideration of such points, development of a load distributed technique for transmitting VOD contents is requested.

Therefore, in an exemplary embodiment of the present invention, a portion or the entire of VOD service data (contents) received from content server 130 through a service provider, i.e., a management server 120 is stored at a hard disk of the set-top box 110, and when access to communication is terminated, a user can again view VOD service data stored at the hard disk through a display device 140.

In order words, in an exemplary embodiment of the present invention, a program viewed by a user is analyzed, data (VOD contents) having a high possibility to view are previously downloaded and stored at a storage device of the set-top box 110, and at a time point in which the user requests, the user can view VOD service data stored at the storage device.

Thereby, according to an exemplary embodiment of the present invention, by reducing a download time without delay of a network, a user can more quickly view VOD contents. Further, according to an exemplary embodiment of the present invention, data (VOD contents) in which a user requests can be permanently stored, and because a download time of VOD service data reduces, a communication cost can be saved.

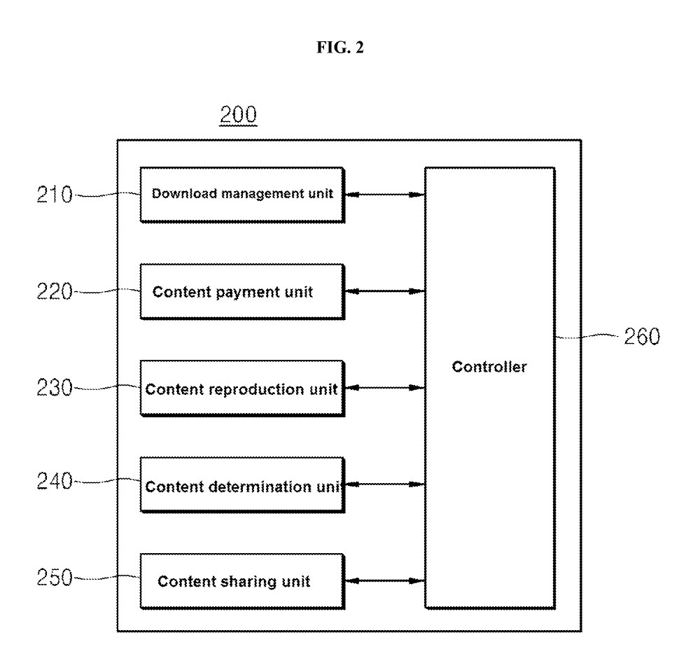

FIG. 2 is a block diagram illustrating a VOD content providing apparatus based on a network load distribution according to an exemplary embodiment of the present invention.

Referring to FIG. 2, a VOD content providing apparatus 200 based on a network load distribution according to an exemplary embodiment of the present invention may include a download management unit 210, a content payment unit 220, a content reproduction unit 230, a content determination unit 240, a content sharing unit 250, and a controller 260. For reference, the VOD content providing apparatus 200 may be mounted in the set-top box 110 of FIG. 1.

The download management unit 210 previously downloads a viewer preference content before a viewing request from a viewer is input in a network idle time period. Here, the network idle time period may be defined to a time period in which a network load is smaller than a reference setting value.

For example, the network idle time period may indicate a time period, in which a network use rate is low, such as a daily work time, a rest time, a viewing time, and a sleep time.

When the previously downloaded viewer preference content is not reproduced during a predetermined time period, the download management unit 210 may delete the viewer preference contents. In this case, the download management unit 210 may sequentially delete a deletion processing target content with a First In First Out (FIFO) method.

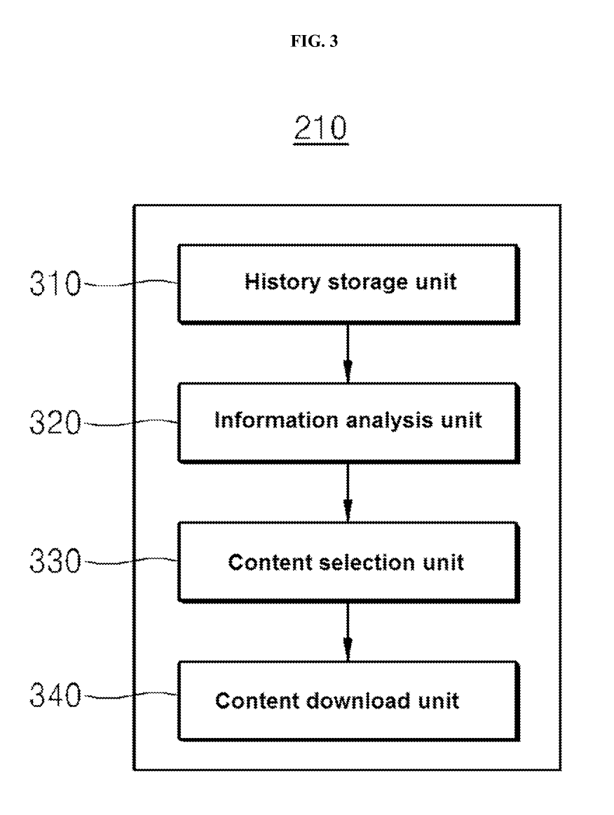

A configuration in which the download management unit 210 downloads a viewer preference content will be described later with reference to FIG. 3.

The content payment unit 220 performs payment on the previously downloaded viewer preference content according to a viewing request of the viewer.

In an exemplary embodiment of the present invention, after the viewer preference contents are previously downloaded, at a time point in which a viewing request for the viewer preference contents is input, payment is performed. That is, in an exemplary embodiment of the present invention, at a time point in which the viewer preference content is downloaded, payment is not performed but after downloading a content, at step of reproducing the content payment is performed.

Conventionally, at step of downloading a content, because accounting and payment was performed, a cost is paid for a content that is not viewed and thus inconvenience and dissatisfaction is caused to a viewer.

However, in an exemplary embodiment of the present invention, after a content is downloaded, at viewing (reproduction) step, because accounting and payment is performed, a cost is paid with a reasonable method and thus inconvenience and dissatisfaction of an existing viewer can be solved.

A payment method on the viewer preference content is already widely used technology such as card payment, point payment, and use fare payment (use fare such as Skylife and cable broadcasting) and thus a detailed description thereof will be omitted.

The content reproduction unit 230 reproduces the viewer preference content in which payment is complete and provides the viewer preference content to the viewer.

That is, the content reproduction unit 230 may reproduce the viewer preference content in which payment is complete and display the viewer preference content in the display device (see 140 of FIG. 1) through the set-top box (see 110 of FIG. 1). Thereby, the viewer may view the viewer preference content displayed in the display device.

The content determination unit 240 may determine whether a viewer preference content in which the viewer wants to view exists in a download list including the downloaded viewer preference contents.

Specifically, the downloaded viewer preference content may be automatically recorded in the download list. Therefore, in the download list, in addition to the downloaded viewer preference content, a previously downloaded viewer preference content(s) may be recorded.

For reference, the download list may be stored at a memory (not shown) connected to the VOD content providing apparatus 200, and the memory may be at least one of an internal memory or an external memory of the VOD content providing apparatus 200.

When a viewing request from the viewer is input, the content determination unit 240 may determine whether a content in which viewing is requested by the viewer, i.e., a content (viewer preference contents) in which the viewer wants to view exists among a plurality of viewer preference contents recorded in the download list.

If a viewer preference content in which the viewer wants to view exists, the content payment unit 220 may perform payment on a corresponding viewer preference content. When payment on the viewer preference content is complete, an entire environment for reproduction (viewing) of the viewer preference content is provided.

If a viewer preference content in which the viewer wants to view does not exist in the download list, the VOD content providing apparatus 200 reproduces the viewer preference content through the content sharing unit 250.

That is, if a content in which viewing is request by the viewer is not found among a plurality of viewer preference contents recorded in the download list, the content sharing unit 250 may search for a storage list of a set-top box within the same network and receive a corresponding viewer preference content.

In this case, when access authority on a storage list of the set-top box within the same network exists, the content sharing unit 250 immediately searches for the storage list and determines whether a corresponding viewer preference content exists, and if a corresponding viewer preference content exists, the content sharing unit 250 may receive the corresponding viewer preference content.

However, when access authority on a storage list of the set-top box within the same network does not exist, the content sharing unit 250 may request access authority on a storage list of the set-top box within the same network to a corresponding set-top box, access the storage list of the corresponding set-top box, and determine whether a corresponding viewer preference content exists.

However, in the storage list of the set-top box within the same network, the corresponding viewer preference content may not be found. In such a case, the download management unit 210 may access to the content server (see 130 of FIG. 1) and download the corresponding viewer preference content in real time.

In this case, the download management unit 210 may monitor a download velocity of the viewer preference contents and compare the download velocity with a buffer processing velocity. If the download velocity is equal to or faster than a buffer processing velocity of the cache memory, the download management unit 210 may first store the downloaded viewer preference content at a storage (not shown) connected to the VOD content providing apparatus 200 and transfer the stored viewer preference content (VOD content) to the cache memory to correspond to a buffer processing velocity of the cache memory.

If the download velocity is slower than the buffer processing velocity, the download management unit 210 may distribute the downloaded VOD contents into the cache memory and the storage.

The download management unit 210 may reproduce an advertisement content upon downloading in real time. Specifically, the download management unit 210 may determine at least one advertisement content to reproduce with reference to a reference table representing a correlation between at least one advertisement content and the VOD content.

When a download velocity of the VOD content is less than a predetermined reference velocity, the download management unit 210 may repeatedly reproduce the determined advertisement content with the number more than a case in which the download velocity is equal to or greater than the predetermined reference velocity. In this case, until a predetermined amount of an entire capacity of the VOD contents is downloaded, the download management unit 210 may continue to reproduce the advertisement content.

The controller 260 may entirely control operation of the VOD content providing apparatus 200 based on a network load distribution, i.e., the download management unit 210, the content payment unit 220, the content reproduction unit 230, the content determination unit 240, and the content sharing unit 250 according to an exemplary embodiment of the present invention.

FIG. 3 is a block diagram illustrating a configuration of the download management unit 210 of FIG. 2.

Referring to FIG. 3, the download management unit 210 may include a history storage unit 310, an information analysis unit 320, a content selection unit 330, and a content download unit 340.

The history storage unit 310 may store history information of a Video On Demand (VOD) content viewed by the viewer. Here, the history information may include viewing time related information, the viewing number, and a kind (genre) of the VOD content.

The information analysis unit 320 may analyze the history information and estimate at least one VOD contents having a high possibility in which the viewer may view in the future based on an analysis result of the history information.

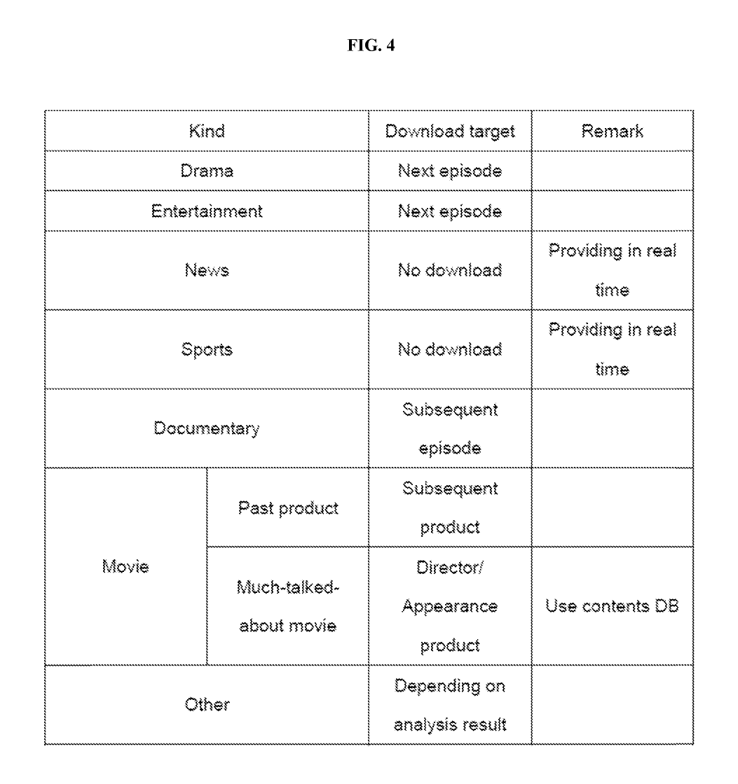

Here, an analysis result of the history information may include the viewing frequency number, a viewing date and time, and a viewing duration time of the viewed content. Further, as shown in FIG. 4, an analysis result of the history information may further include data such as a content kind (e.g., drama, entertainment, news, sports, documentary, movie (past product/much-talked-about movie), others), the broadcasting episode number, information on whether a subsequent episode exists, information on a real time content, a download target (e.g., a next episode in a drama or entertainment, a real time content such as in news or sports is not downloaded, and in a documentary or movie, a subsequent episode (subsequent product, director/appearance product). For reference, FIG. 4 is a table illustrating an analysis result of history information of VOD contents according to an exemplary embodiment of the present invention.

The content selection unit 330 may select the estimated at least one VOD content to the viewer preference content.

The content download unit 340 may download the selected viewer preference content in the network idle time period.

The download management unit 210 may calculate a duration time of the network idle time period and calculate a download velocity of the network idle time period. The download management unit 210 may calculate the download available number of the viewer preference contents during the duration time based on the download velocity. The download management unit 210 may previously download the viewer preference contents corresponding to the download available number in the network idle time period.

Alternatively, while the download management unit 210 continues to download at least one of viewer preference contents in the network idle time period regardless of the download available number, when the download velocity drops to a reference setting value or less in spite of the network idle time period, the download management unit 210 may pause download of the downloading viewer preference content.

Thereby, according to an exemplary embodiment of the present invention, by distributing a network load, complexity of the network can be reduced and thus by reducing a download time of the viewer preference content, a communication cost burden of a user can be reduced.

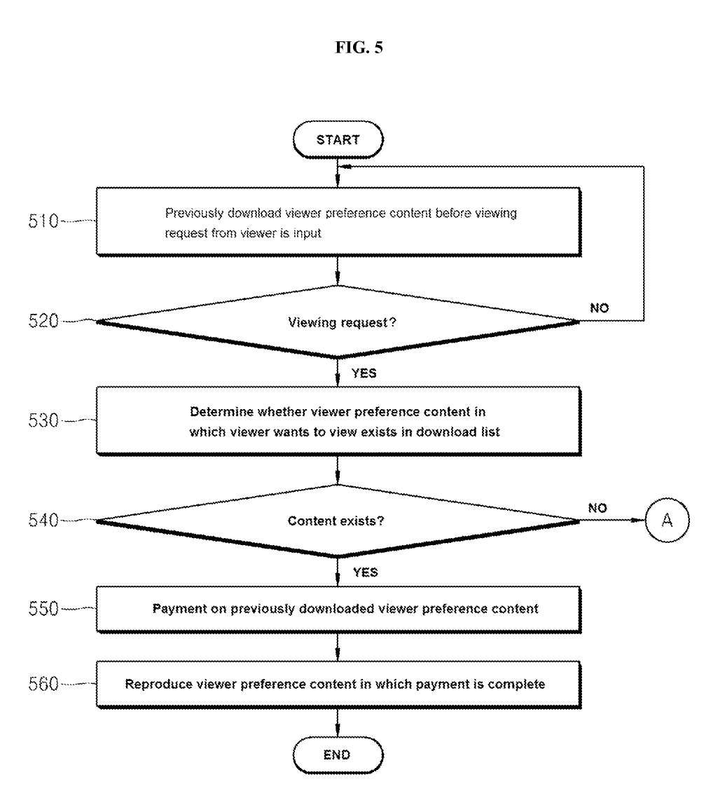

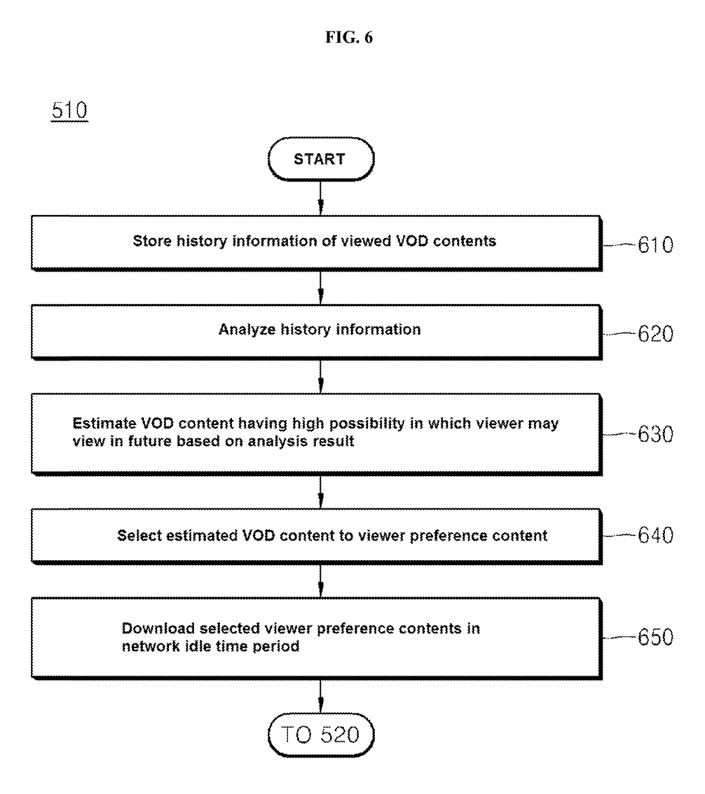

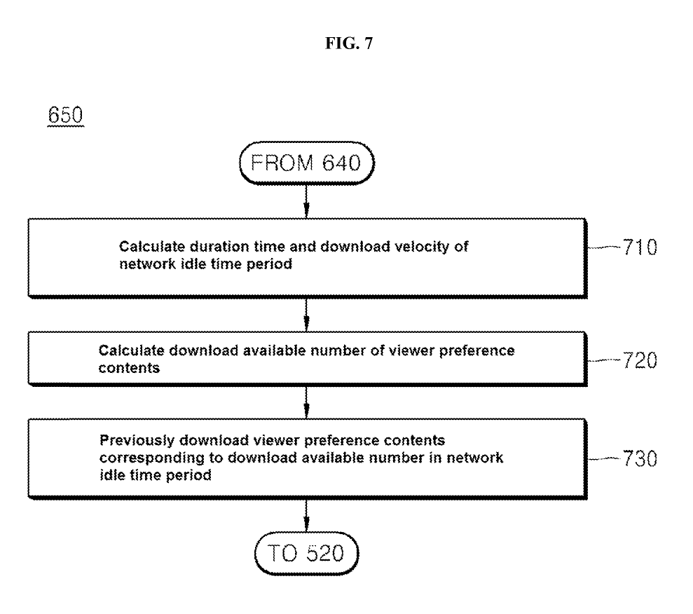

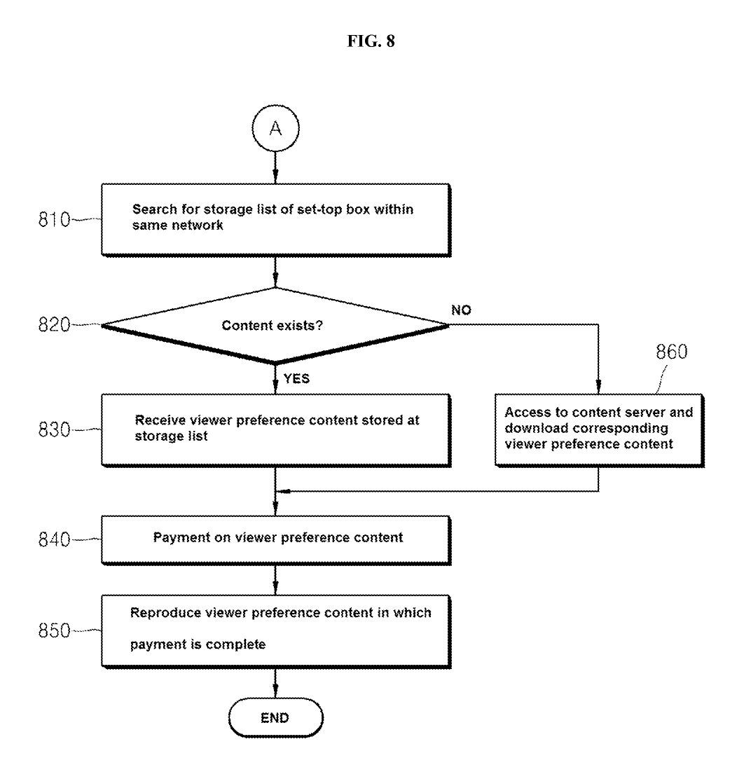

FIGS. 5 to 8 are flowcharts illustrating a method of providing a VOD content based on a network load distribution according to an exemplary embodiment of the present invention. Particularly, FIGS. 6 and 7 are flowcharts illustrating a process of previously downloading a viewer preference content in a network idle time period according to an exemplary embodiment of the present invention, and FIG. 8 is a flowchart illustrating a process of sharing a content according to an exemplary embodiment of the present invention. Here, a method of providing the VOD content may be performed by the VOD content providing apparatus 200 of FIG. 2.

First, referring to FIG. 5, the download management unit 210 of the VOD content providing apparatus 200 previously downloads a viewer preference content before a viewing request from a viewer is input in the network idle time period (510). A process of previously downloading the viewer preference content is as follows.

As shown in FIG. 6, the history storage unit 310 of the download management unit 210 stores history information of VOD contents viewed by the viewer (610).

Thereafter, the information analysis unit 320 of the download management unit 210 analyzes the history information (620).

Thereafter, the information analysis unit 320 of the download management unit 210 estimates at least one VOD content having a high possibility in which the viewer may view in the future based on an analysis result of the history information (630).

Thereafter, the content selection unit 330 of the download management unit 210 selects the estimated at least one VOD content to the viewer preference content (640).

Thereafter, the content download unit 340 of the download management unit 210 downloads the selected viewer preference content in the network idle time period (650).

In this case, as shown in FIG. 7, the content download unit 340 of the download management unit 210 calculates a duration time and a download velocity of the network idle time period (710).

Thereafter, the content download unit 340 of the download management unit 210 calculates the download available number of the viewer preference contents during the duration time based on the download velocity (720).

Thereafter, the content download unit 340 of the download management unit 210 previously downloads the viewer preference contents corresponding to the download available number in the network idle time period (730).

Referring again to FIG. 5, the content determination unit 240 determines whether a viewing request for the viewer preference contents is input (520), and if a viewing request for the viewer preference contents is input, the content determination unit 240 of the VOD content providing apparatus 200 determines whether a viewer preference content in which the viewer wants to view exists in a download list including the downloaded viewer preference content (530).

If a viewer preference content in which the viewer wants to view exists in a download list at step 540, the content payment unit 220 of the VOD content providing apparatus 200 performs payment on the previously downloaded viewer preference content (550).

Thereafter, the content reproduction unit 230 of the VOD content providing apparatus 200 reproduces the viewer preference content in which payment is complete and provides the viewer preference content to the viewer (560).

If a viewer preference content in which the viewer wants to view does not exist in a download list at step 540, the VOD content providing apparatus 200 performs a process “A” of FIG. 8.

That is, as shown in FIG. 8, the content sharing unit 250 of the VOD content providing apparatus 200 searches for a storage list of a set-top box within the same network (810).

The content determination unit 240 determines whether a corresponding viewer preference content exists at the storage list (820), and if a corresponding viewer preference content exists at the storage list, the content sharing unit 250 of the VOD content providing apparatus 200 receives a viewer preference content stored at the storage list (830).

If a corresponding viewer preference content does not exist at the storage list at step 820, the download management unit 210 of the VOD content providing apparatus 200 accesses to the content server and downloads the corresponding viewer preference content in real time (860).

Thereafter, the content payment unit 220 of the VOD content providing apparatus 200 performs payment on the received (or downloaded in real time) viewer preference content (840).

Thereafter, the content reproduction unit 230 of the VOD content providing apparatus 200 reproduces the viewer preference content in which payment is complete and provides the viewer preference content to the viewer (850).

In this way, in an exemplary embodiment of the present invention, contents viewed by the viewer are analyzed, contents having a high possibility to view can be previously downloaded and stored, and at a time point in which the viewer requests, the stored contents can be reproduced.

Therefore, according to an exemplary embodiment of the present invention, by reducing a download time without delay of a network, a viewer can more quickly view a content. Further, according to an exemplary embodiment of the present invention, a content in which a viewer requests can be permanently stored, and because a download time of a content reduces, a communication cost can be saved.

Exemplary embodiments of the present invention include a computer readable medium including a program instruction for performing operation implemented with various computers. The computer readable medium may include a program instruction, a local data file, and a local data structure in single or in combination. The medium may be especially designed and configured for the present invention or may be known and used to a person of ordinary skill in the art. The computer readable recording medium may include, for example, a magnetic medium such as a hard disk, a floppy disk, and a magnetic tape, an optical recording medium such as a Compact Disk Read-Only Memory CD-ROM) or a Digital Versatile Disk (DVD), a magnetic-optical medium such as a floptical disk, and a hardware device, specially configured to store and perform a program instruction, such as a ROM, a Random-Access Memory (RAM), and a flash memory. The program instruction may include, for example, a high-level language code that may be executed by a computer using an interpreter as well as a machine language code formed by a compiler.

In the foregoing description, an exemplary embodiment of the present invention has been described, but several changes may be performed within the scope without deviating from the scope of the present invention. Therefore, the scope of the present invention is not limited to the described exemplary embodiment but should be determined by the appended claims and their equivalents.

Although exemplary embodiments of the present invention have been described in detail hereinabove it should be clearly understood that many variations and modifications of the basic inventive concepts herein described which may appear to those skilled in the art will still fall within the spirit and scope of the exemplary embodiments of the present invention as defined in the appended claims. All such changes, modifications and alterations should therefore be seen as within the scope of the present invention.

### Industrial Applicability

The present invention may be used in a technical field related to VOD contents.

1. A VOD content providing apparatus based on a network load distribution, comprising:
a download management unit that previously downloads viewer preference contents before a viewing request from a viewer is input in a network idle time period defined to a time period in which a network load is smaller than a reference setting value;
a content payment unit that performs payment on the previously downloaded viewer preference contents according to a viewing request from the viewer; and
a content reproduction unit that reproduces the viewer preference content in which payment is complete and that provides the viewer preference content to the viewer.

2. The VOD content providing apparatus of claim 1, wherein the download management unit comprises:
a history storage unit that stores history information of Video On Demand (VOD) contents viewed by the viewer;
an information analysis unit that analyzes the history information and that estimates at least one VOD contents having a high possibility in which the viewer may view in the future based on an analysis result of the history information;
a content selection unit that selects the estimated at least one VOD contents to the viewer preference contents; and
a content download unit that downloads the selected viewer preference contents in the network idle time period.

3. The VOD content providing apparatus of claim 2, wherein an analysis result of the history information comprises at least one of the viewing frequency number of the viewed contents, a viewing date and time, a viewing duration time, the broadcasting episode number, and information on whether a subsequent episode exists.

4. The VOD content providing apparatus of claim 1, further comprising a content determination unit that determines whether a viewer preference content in which the viewer wants to view exists in a download list comprising the downloaded viewer preference contents,
wherein the content payment unit performs, if a viewer preference content in which the viewer wants to view exists, payment on a corresponding viewer preference content.

5. The VOD content providing apparatus of claim 4, further comprising a content sharing unit that searches for a storage list of the set-top box within the same network and that receives a corresponding viewer preference content, when a viewer preference content in which the viewer wants to view does not exist in the download list.

6. The VOD content providing apparatus of claim 5, wherein the download management unit accesses to the content server to download a corresponding viewer preference content in real time, when the corresponding viewer preference content is not found in the storage list of the set-top box within the same network.

7. The VOD content providing apparatus of claim 1, wherein the download management unit deletes the previously downloaded viewer preference content, when the previously downloaded viewer preference content is not reproduced during a predetermined time.

8. The VOD content providing apparatus of claim 1, wherein the download management unit calculates a duration time and a download velocity of the network idle time period, calculates the download available number of the viewer preference contents during the duration time based on the download velocity, and previously downloads the viewer preference contents corresponding to the download available number in the network idle time period.

9. A method of providing a VOD content based on a network load distribution, the method comprising:
previously downloading, by a download management unit of a VOD content providing apparatus, a viewer preference content before a viewing request from a viewer is input in a network idle time period defined to a time period in which a network load is smaller than a reference setting value;
performing, by a content payment unit of the VOD content providing apparatus, payment on the previously downloaded viewer preference contents according to a viewing request from a viewer; and
reproducing, by a content reproduction unit of the VOD content providing apparatus, the viewer preference content in which payment is complete and providing the viewer preference content to the viewer.

10. The method of claim 9, wherein the previously downloading of a viewer preference content comprises:
storing, by a history storage unit of the download management unit, history information of a VOD content viewed by the viewer;
analyzing, by an information analysis unit of the download management unit, the history information and estimating at least one VOD contents having a high possibility in which the viewer may view in the future based on an analysis result of the history information;
selecting, by a content selection unit of the download management unit, the estimated at least one VOD contents to the viewer preference contents; and
downloading, by a content download unit of the download management unit, the selected viewer preference contents in the network idle time period.

11. The method of claim 9, further comprising determining, by a content determination unit of the VOD content providing apparatus, whether a viewer preference content in which the viewer wants to view exists in a download list including the downloaded viewer preference content,
wherein the performing of payment comprises performing, if a viewer preference content in which the viewer wants to view exists, payment on a corresponding viewer preference content.

12. The method of claim 11, further comprising searching for, if a viewer preference content in which the viewer wants to view does not exist in the download list, by a content sharing unit of the VOD content providing apparatus, a storage list of a set-top box within the same network and receiving a corresponding viewer preference content.

13. The method of claim 9, further comprising:
calculating, by the download management unit of the VOD content providing apparatus, a duration time of the network idle time period and a download velocity of the network idle time period;
calculating, by the download management unit of the VOD content providing apparatus, the download available number of the viewer preference contents during the duration time based on the download velocity; and
previously downloading, by the download management unit of the VOD content providing apparatus, the viewer preference content corresponding to the download available number in the network idle time period.
